(19) United States
(12) Patent Application Publication
(10) Pub. No.: US 2026/0071738 A1
(43) Pub. Date: Mar. 12, 2026

(54) Trimless Canopy for Lighting Fixture

(71) Applicant: Allied Maker, LLC, Glen Cove, NY (US)

(72) Inventor: Ryden Rizzo, Sea Cliff, NY (US)

(21) Appl. No.: 19/327,032

(22) Filed: Sep. 12, 2025

Related U.S. Application Data
(60) Provisional application No. 63/694,078, filed on Sep. 12, 2024.

(51) Int. Cl. F21V 21/04; F21V 23/00

(52) U.S. Cl. CPC F21V 21/043; F21V 23/002

(57) ABSTRACT

Lighting fixture canopies generally need to be at least 4 to 5 inches in diameter to adequately cover a standard junction box, resulting in a bulky, obtrusive appearance that detracts from the overall design and clean lines of a space. A trimless canopy significantly reduces the size of the visible components, resulting in a more minimal and elegant appearance. The design offers a flush installation where the fixture blends seamlessly with the surrounding surface, minimizing the visual impact of the canopy while maintaining the required functionality.

### RELATED APPLICATIONS

This application claims priority to U.S. Provisional Application 63/694,078 the contents of which are hereby incorporated by reference in their entirety.

### FIELD OF THE INVENTION

The present invention relates generally to lighting fixtures, and more specifically, to a Trimless Canopy for Lighting Fixtures designed for seamless integration with walls or ceilings. This assembly features a versatile mounting plate, mud plate, and socket assembly for easy installation with standard or custom junction boxes while minimizing the size of the visible canopy.

### BACKGROUND OF THE INVENTION

Lighting fixtures are integral to both the aesthetic and functional aspects of a room. However, the process of installing traditional lighting fixtures is often cumbersome and involves cutting into the wall or ceiling surface to install a junction box, which houses the electrical connections. Once the junction box is in place, a large, obtrusive canopy is typically required to cover the junction box and mounting hardware, securing the fixture.

A canopy, in the context of lighting fixtures, refers to the covering that conceals the junction box and the associated hardware. It typically sits on top of the surface of the wall or ceiling and is the visible part of the fixture where it meets the surface. Canopies generally need to be at least 4 to 5 inches in diameter to adequately cover a standard junction box, resulting in a bulky, obtrusive appearance that detracts from the overall design and clean lines of a space.

One object of the present invention is to provide a Trimless Canopy that significantly reduces the size of the visible components, resulting in a more minimal and elegant appearance. This Trimless Canopy design offers a flush installation where the fixture blends seamlessly with the surrounding surface, minimizing the visual impact of the canopy while maintaining the required functionality. Although the installation process may be more labor-intensive, this design is specifically aimed at reducing the canopy size without sacrificing the fixture's ability to function with industry-standard or custom junction boxes, making it versatile for various installations.

### SUMMARY

An embodiment of a Trimless Canopy for Lighting Fixtures comprises a flat mud plate portion, configured to be plastered-over and painted-over to provide a smooth appearance with respect to a wall or ceiling on which the canopy is mounted. The mud plate portion has a central aperture. The canopy also includes a mounting plate portion connected to the mud plate portion and configured to attach to a junction box. The mounting plate portion has a pocket section configured to align with the central aperture of the mud plate portion and to fit within the junction box, and the pocket section has a pocket aperture configured to allow electrical wires from the junction box to pass through the canopy to power a lighting fixture. The canopy also includes a socket assembly configured to fit within the pocket section and to be affixed to the mounting plate portion, and to serve as an attachment point for a lighting fixture.

In an embodiment, the mud plate portion and the mounting plate portion are separate components. In another embodiment the mud plate portion and the mounting plate portion are each part of a single component. The mud plate portion may have a thickness of 2 mm or less. The mud plate portion may be circular in shape. The junction box may be a standard junction box.

### BRIEF DESCRIPTION OF THE DRAWINGS

FIG. 1 is top front view of the lighting assembly fully assembled;

FIG. 2 is a bottom rear view of the present invention fully assembled;

FIG. 3 is a top perspective view of the mounting plate of the present invention;

FIG. 4 is a front elevational view of the mounting plate of the present invention;

FIG. 5 is a front top right view of the mounting plate of the present invention;

FIG. 6 is a front view of the mud plate of the present invention;

FIG. 7 is a front-top-right view of the mud plate of the present invention.

FIG. 8 is an front-top view of the socket assembly of the present invention;

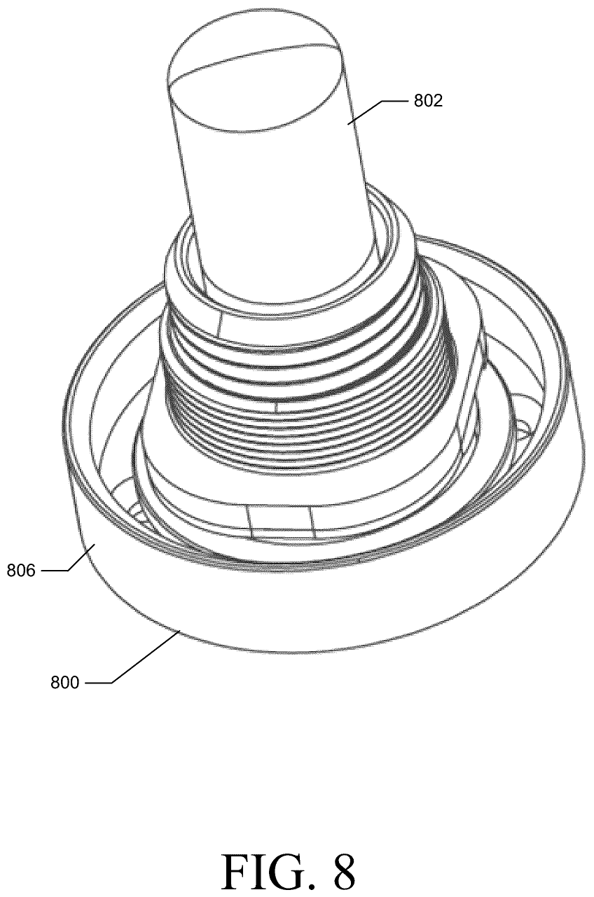

FIG. 9 is a bottom view of the socket assembly of the present invention;

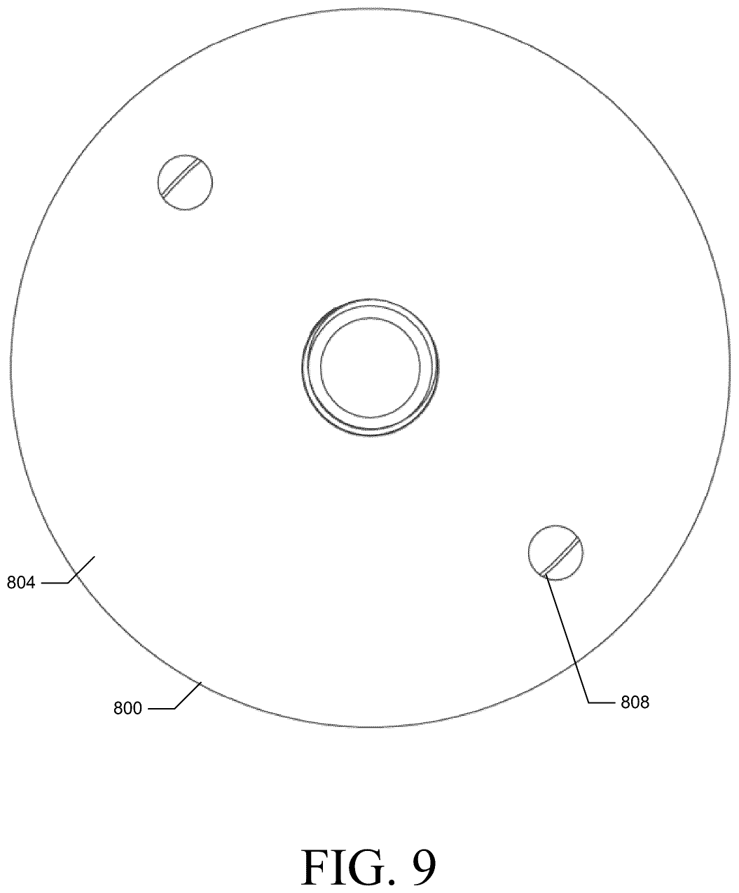

FIG. 10 is a front view of the socket assembly of the present invention; and

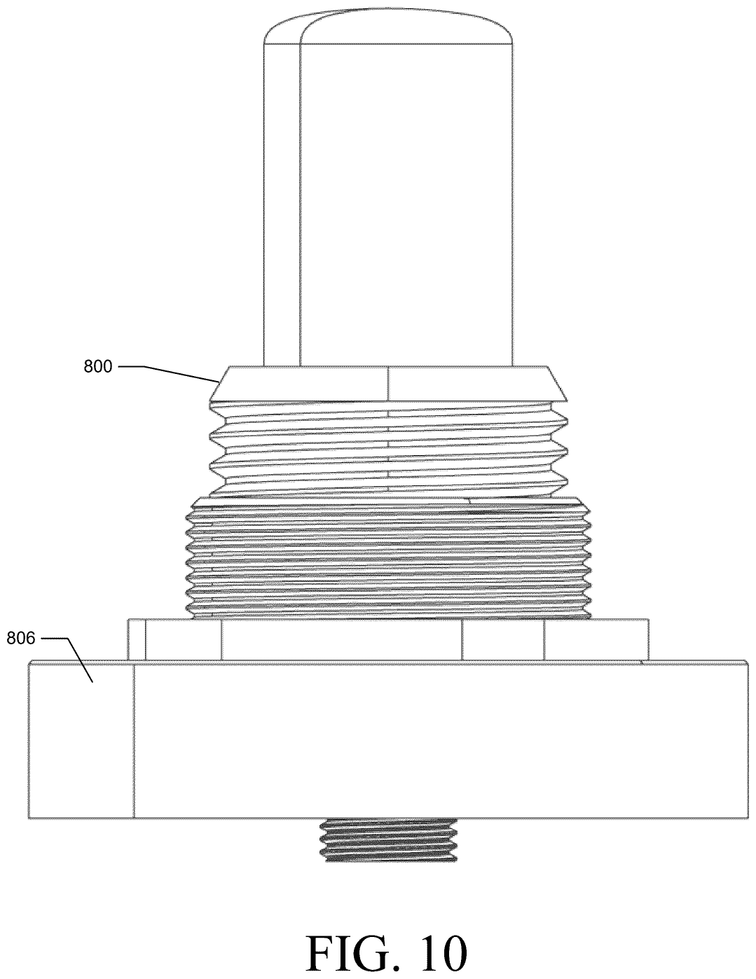

FIG. 11 is top view of the socket assembly of the present invention.

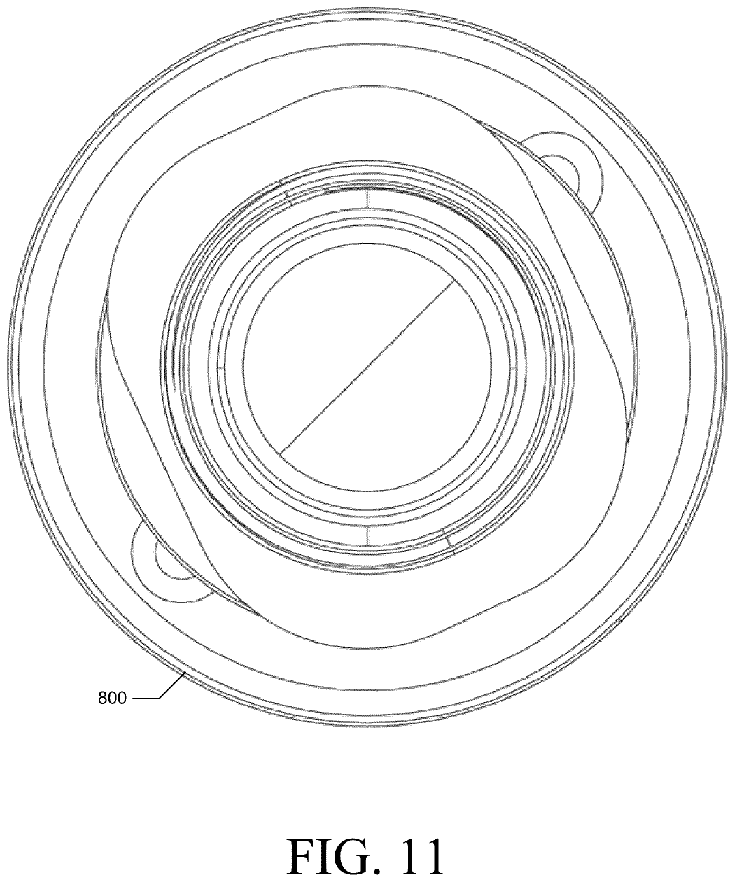

### DETAILED DESCRIPTION

All illustrations of the drawings are for the purpose of describing selected embodiments of the present invention and are not intended to limit its scope.

The present invention is a Trimless Canopy for Lighting Fixtures designed to create a clean, seamless appearance when installed. The primary feature of this invention is the significant reduction in the size of the canopy that covers the junction box. Traditional canopies are often large and obtrusive, but the Trimless Canopy reduces the size of these visible components while ensuring that the fixture remains functional and compatible with standard or custom junction boxes. The flush appearance of the Trimless Canopy is an added benefit, appealing to those seeking a more refined aesthetic.

To achieve the trimless effect, the invention employs a mounting plate 300, a mud plate 600, and a socket assembly 800. These components work together to securely mount the lighting fixture while significantly reducing the size of the visible canopy, resulting in a more minimal and unobtrusive, substantially flush, appearance. The mud plate 600 may have a thickness of 5 mm or less, including 4 mm, 3 mm, 2 mm, or 1 mm.

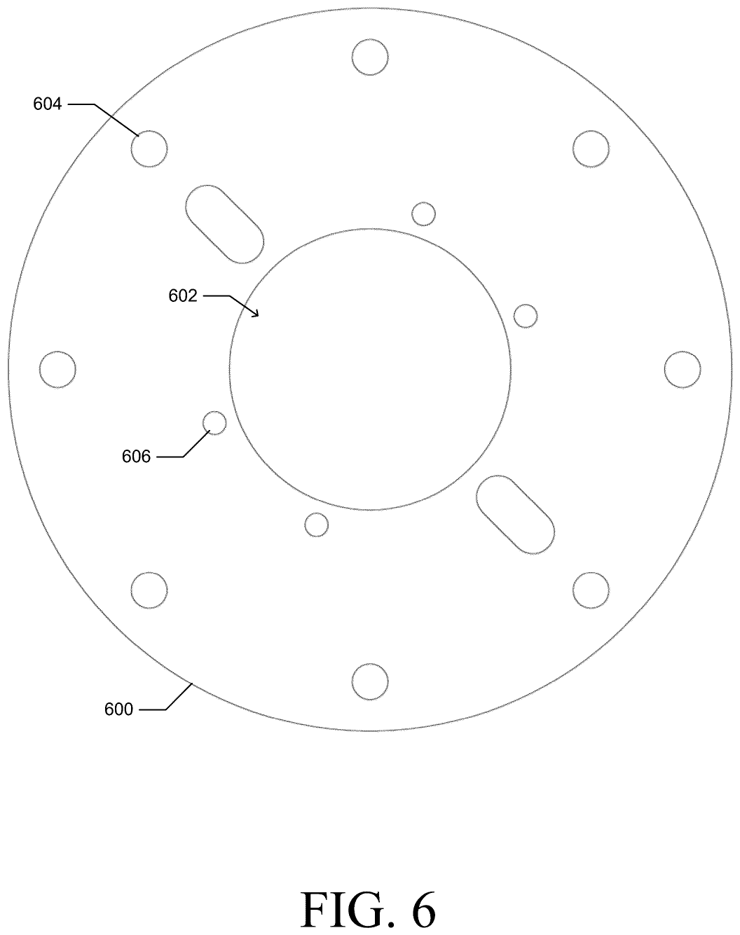

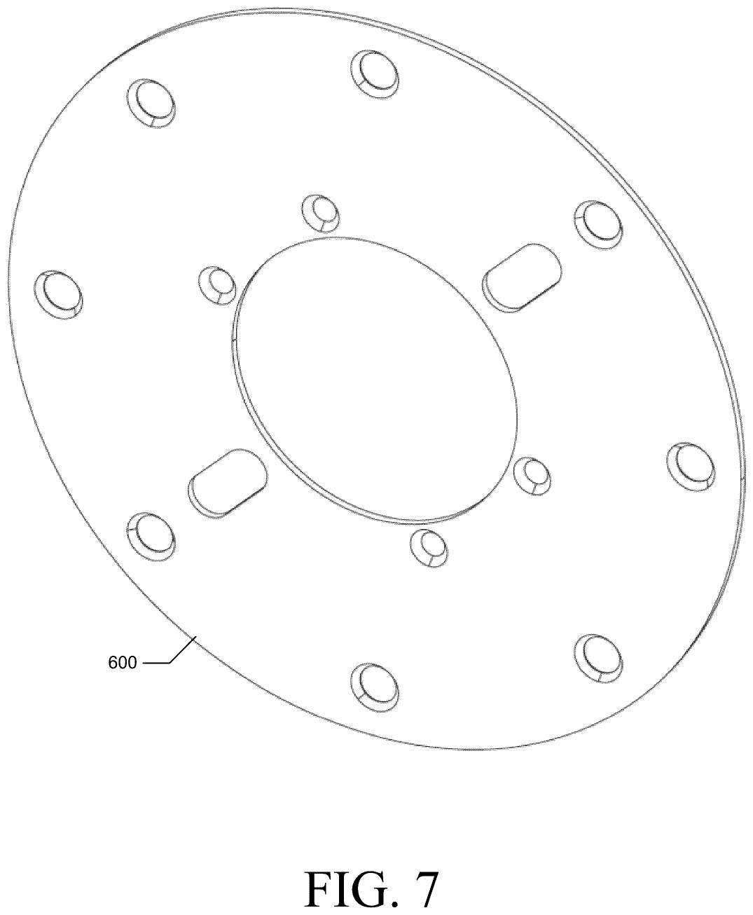

As shown in FIGS. 6 and 7, the mud plate 600 is a circular disk designed to be secured to the mounting plate 300, which is connected to the junction box. The mud plate 600 can be made of metal, plastic, or any other suitable material that supports the intent of the invention. It features a central aperture 602 that allows electrical wires from the junction box to pass through and connect with the wires from the socket assembly 800, ensuring proper electrical connectivity between the junction box and the lighting fixture.

A key feature of the Trimless Canopy is its ability to significantly reduce the overall diameter of the canopy, creating a more minimal and unobtrusive appearance when installed into drywall or similar surfaces. During installation, the mud plate 600 is designed to be covered with plaster, spackle, joint compound or other finishing mediums. These materials are applied over the mud plate 600 and then sanded down to create a smooth, seamless surface that blends with the surrounding wall or ceiling. Once the surface is finished and painted, the entire mud plate 600 is concealed, leaving only the internal aperture visible for the installation of the socket assembly 800.

The mud plate 600 also includes multiple external attachment apertures 604 positioned near its outer edge, which serve to secure it to the wall or ceiling via fasteners. Additionally, the mud plate 600 features internal connection points 606 near the central aperture. These internal connection points 606 are, in one embodiment, counter-sunk screw holes that align with tapped, threaded holes in the mounting plate, allowing the mud plate 600 to be fastened securely to the mounting plate 300 with screws. Alternatively, the mud plate 600 and mounting plate 300 can be joined through welding or other methods. This flexibility ensures a strong and reliable connection between the two components while maintaining the flush appearance of the final installation.

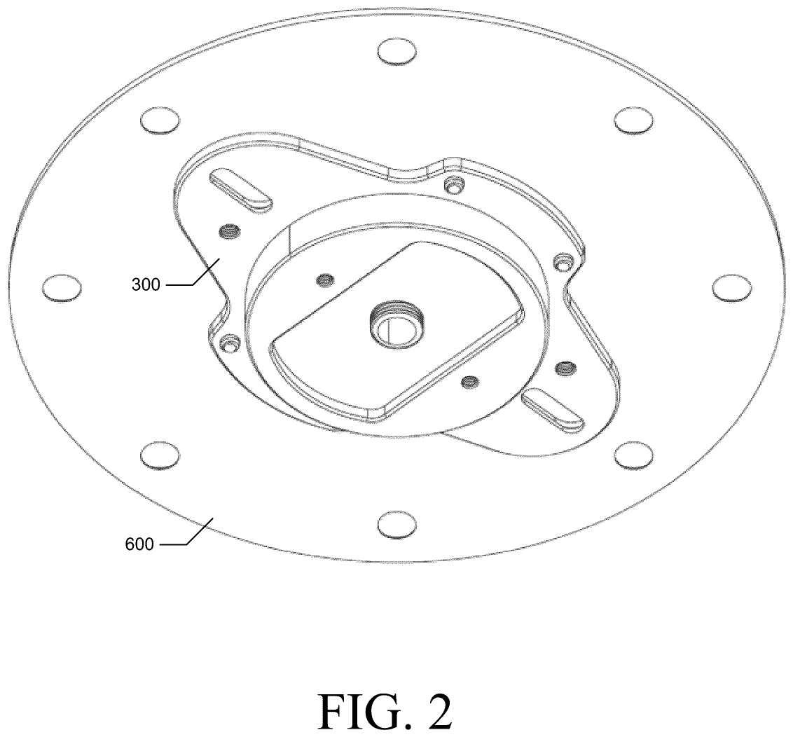

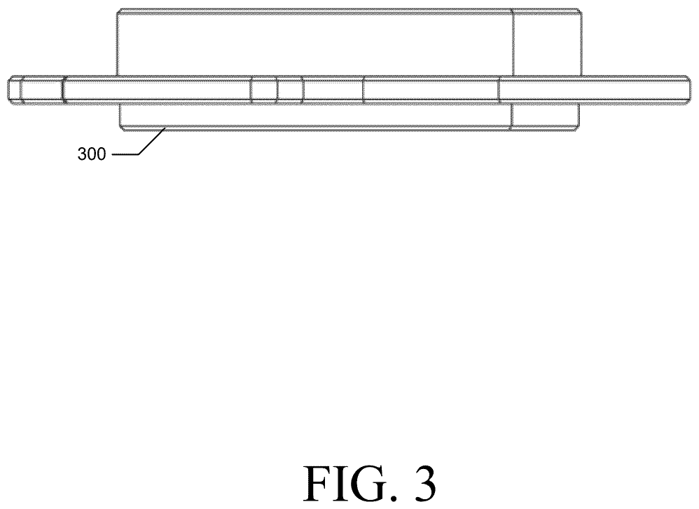

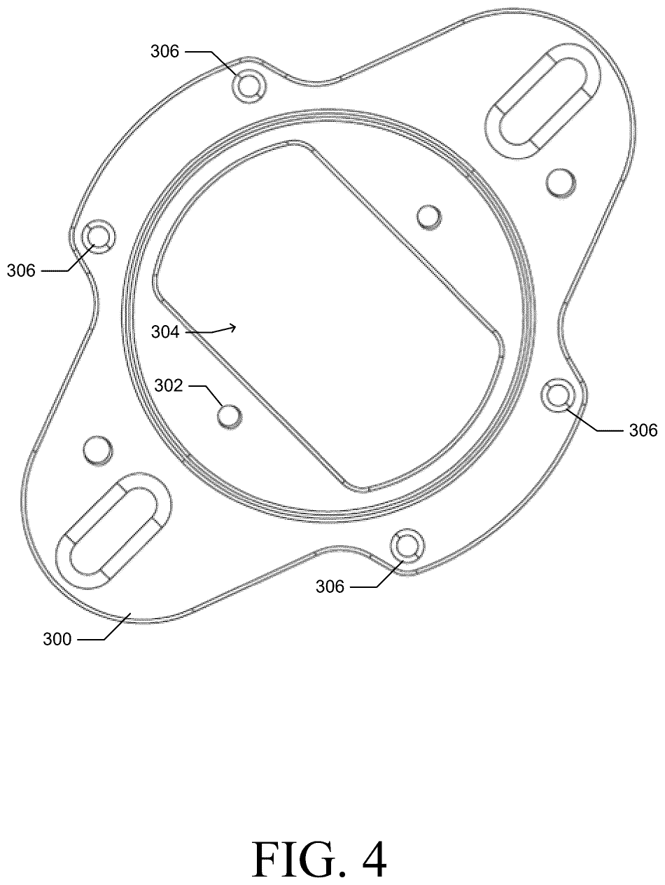

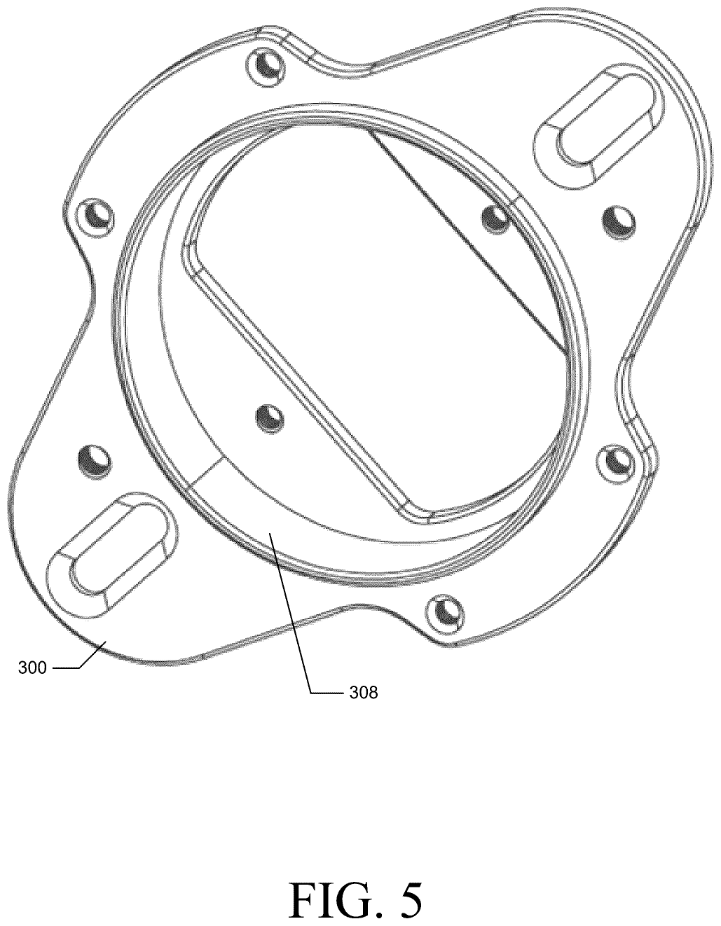

Referring to FIGS. 2 through 5, the mounting plate 300 is configured to be positioned on the back face of the mud plate 600 and to be secured to a junction box. In an embodiment, the mounting plate 300 is designed with an overall oval shape and two wings extending outward to ensure proper alignment and secure attachment to a standard junction box. The size and hole spacing may be specifically configured to fit within commonly available junction boxes. This design provides a stable foundation at the mounting point, ensuring that the light fixture is securely supported where it meets the wall or ceiling surface. The mounting plate 300 includes a plurality of apertures 302 across its surface to allow secure fastening to the junction box using screws. A central aperture 304 aligns with the central aperture 602 of the mud plate, allowing the electrical wires from the junction box to pass through both plates and connect to the socket assembly 800. The mounting plate 300 includes a pocket 308, which is configured to house at least a portion of the socket assembly 800.

The mounting plate 300 also features internal connection points 306 that align with those on the mud plate 600. These points 306 can be used to fasten the two plates together with screws, other fasteners, or other methods, such as welding, depending on the desired application or manufacturing process. This ensures a secure connection between the mud plate 600 and mounting plate 300, providing structural integrity during installation.

While this invention currently employs a separate mounting plate 300 and mud plate 600 for economic and manufacturing efficiency, the functional elements of both components can be combined into a single unit. By machining the mud plate 600 from a thicker stock of material, the necessary features-such as pockets and apertures-can be integrated directly. This design variation is contemplated without departing from the invention's scope, ensuring versatility in both separate and combined configurations.

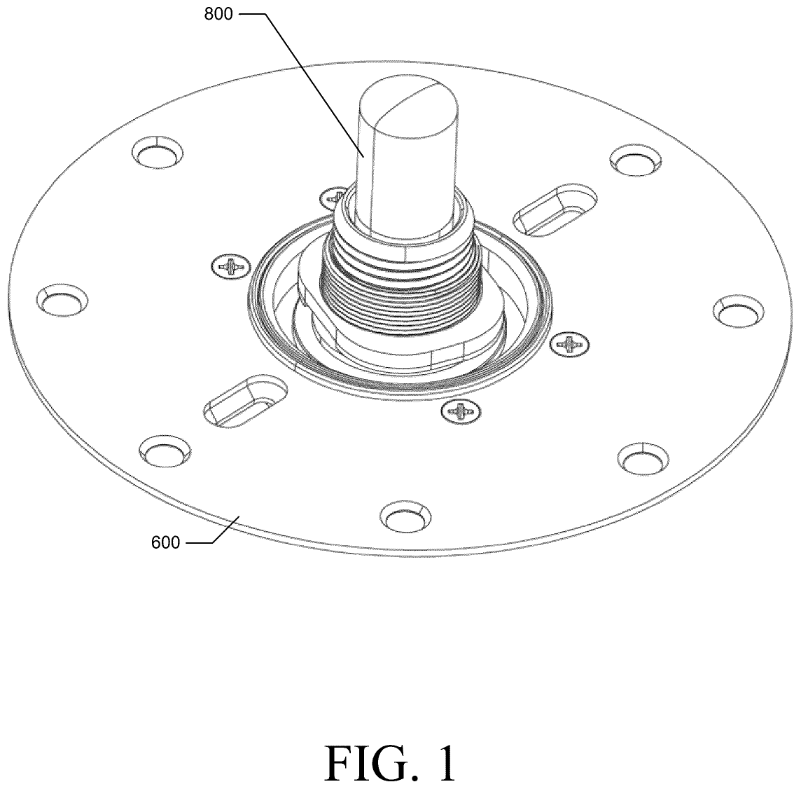

As illustrated in FIG. 1, and 8 through 11, the socket assembly 800 may be designed to fit securely within the pocket 308 of the mounting plate 300. The socket assembly 800 is versatile in design, allowing it to serve as a connection point for various types of lighting fixtures. The central stem 802 can accommodate a simple bulb and glass covering, or alternatively, it can serve as the attachment point for more complex lighting fixtures, such as sconces, pendants, or tubular lights.

The socket assembly 800 includes a floor wall 804 and a side wall 806, providing structural support to ensure the component remains securely positioned within the mounting plate's pocket 308. The floor wall 804 of the socket assembly features apertures 808 or other connection points that allow it to be securely fastened to the mounting plate 300. This could include screws, external threading on the outer walls of the socket assembly 800, or other attachment methods. This flexibility ensures that, regardless of the type of lighting fixture being used-whether a simple bulb or a more complex fixture such as a sconce or pendant-the assembly remains properly connected and stable. The design accommodates a wide range of configurations without compromising the structural integrity of the overall fixture.

While the present invention has been described with reference to a preferred embodiment, it is understood that various modifications and adaptations can be made without departing from the spirit and scope of the invention. The described invention offers a sleek, Trimless Canopy for a lighting fixture that integrates seamlessly into walls or ceilings while minimizing the size of the visible canopy. The invention is compatible with both standard and custom junction boxes, allowing for future innovations in lighting design and installation.

1. A lighting fixture canopy, comprising:
a flat mud plate portion configured to be plastered-over and painted-over to provide a smooth appearance with respect to a wall or ceiling on which the canopy is mounted, the mud plate portion having a central aperture;
a mounting plate portion connected to the mud plate portion and configured to attach to a junction box, the mounting plate portion having a pocket section configured to align with the central aperture of the mud plate portion and to fit within the junction box, the pocket section having a pocket aperture configured to allow electrical wires from the junction box to pass through the canopy; and
a socket assembly configured to fit within the pocket section and to be affixed to the mounting plate portion, and to serve as an attachment point for a lighting fixture.

2. The lighting fixture canopy of claim 1, wherein the mud plate portion and the mounting plate portion are separate components.

3. The lighting fixture canopy of claim 1, wherein the mud plate portion and the mounting plate portion are each part of a single component.

4. The lighting fixture canopy of claim 1, wherein the mud plate portion has a thickness of 2 mm or less.

5. The lighting fixture canopy of claim 1, wherein the mud plate portion is circular in shape.

6. The lighting fixture canopy of claim 1, wherein the junction box is a standard junction box.
